(19) United States
(12) Patent Application Publication
(10) Pub. No.: US 2021/0094019 A1
(43) Pub. Date: Apr. 1, 2021

(54) COMPOSITIONS COMPRISING PLATINUM NANOPARTICLE CLUSTERS WITH IMPROVED THERMOSTABILITY

(71) Applicants: Johnson Matthey Public Limited Company, London (GB); Tokyo University of Science Foundation, Tokyo (JP)

(72) Inventors: Shuhei NAGAOKA, Tochigi (JP); Yuichi FUJIMORI, Tochigi (JP); Tomoharu HAYAMA, Tochigi (JP); Yuichi NEGISHI, Tokyo (JP); Wataru KURASHIGE, Tokyo (JP); Atsuya HARASAWA, Tokyo (JP); Nobuyuki SHIMIZU, Tokyo (JP)

(21) Appl. No.: 17/048,487

(22) PCT Filed: Mar. 29, 2019
(86) PCT No.: PCT/JP2019/013991

§ 371 Date: Oct. 16, 2020

(30) Foreign Application Priority Data
Apr. 16, 2018 (JP) 2018-078117

(51) Int. Cl. B01J 23/42; B01J 21/04; B01J 35/00; B01J 37/10; B01D 53/94

(52) U.S. Cl. CPC B01J 23/42; B01J 21/04; B01J 35/0013; B01D 2255/9202; B01D 53/944; B01D 2255/1021; B01J 37/10

(57) ABSTRACT

A composition comprising platinum (Pt) nanoparticles and an inorganic oxide, wherein the Pt nanoparticles have no more than 100 Pt atoms, wherein the Pt nanoparticles have a mean particle size of 1 nm to 10 nm with a standard deviation (SD) no more than 1 nm.

### TECHNICAL FIELD

The present invention relates to a novel composition comprising platinum (Pt) nanoparticles and an inorganic oxide with improved thermostability.

### BACKGROUND OF THE INVENTION

Since the platinum group metal (PGM) is excellent in heat resistance and tactile resistance, and has catalytic properties and the like, it has conventionally been used in various fields as automobile exhaust gas catalysts, electrode materials and the like. The PGM is usually used as highly dispersed nanoparticles which are supported on inorganic carrier materials (e.g. high-surface-area alumina, carbon and so on) to obtain larger number of the active site with the higher surface area. However, the thermal stability of PGM is significantly reduced with decreased size of the particle, for instance, the melting temperature of face-centered-cubic (fcc) based Pt is rapidly decreased at the size below 20 to 30 nm diameter (e.g., see, Nanoscale Research Letters, 2011, 6, 396). Therefore, the PGM nanoparticles are sintered during harsher ageing condition e.g. hydrothermal at 1000° C. for automotive exhaust gas catalyst to be deactivated through loss of active site.

On the other hand, non-fcc type PGM nanoparticle clusters with the size below 100 atoms has been found and they are known to exhibit unique chemical properties different from bulk metals, and studies therefor are conducted in various fields. In platinum clusters, for example, academic studies of the oxidation catalyst properties against carbon monoxide has been conducted (e.g., see, Journal of the American Chemical Society, 1999, 121 (13), 3214-3217; Journal of Materials Chemistry A, 2017, 5, 4923-4931; and Catalysis Science & Technology, 2011, 1, 1490-1495) while the operation temperatures are not harsh since the thermostable properties of Pt cluster materials has been expected very low.

Thus, the present invention provides a novel composition comprising platinum nanoparticle clusters with improved thermostabilities.

### SUMMARY OF THE INVENTION

One aspect of the present disclosure is directed to a composition comprising platinum (Pt) nanoparticles and an inorganic oxide, wherein the Pt nanoparticles have no more than 100 Pt atoms, wherein the Pt nanoparticles have a mean particle size of 1 nm to 10 nm with a standard deviation (SD) no more than 1 nm.

### BRIEF DESCRIPTION OF DRAWINGS

FIG. 1 shows a flow diagram to synthesis triphenylphosphine (TPP)-protected Pt cluster.

FIG. 2 shows an example of MALDI mass spectrum of synthesized TPP-protected platinum cluster.

FIG. 3 shows a flow diagram to synthesis phenyl ethanethiol (PET)-protected Pt cluster.

FIG. 4 shows an example of MALDI mass spectrum of synthesized PET-protected platinum cluster (Examples 2A-2D).

FIG. 5 shows an electron micrograph of a substance having a platinum cluster of 17 atoms (4.2 kDa) whose content is more than 70% of total Pt nanoparticle cluster on alumina according to Example 1.

FIG. 6 shows an electron micrograph of a substance having a platinum cluster of 62 atoms (14 kDa) with the distribution of +/−5 atoms at full-width half-maximum on alumina according to Example 2C.

FIG. 7 shows an electron micrograph of platinum-supporting alumina synthesized by an impregnation method utilizing a platinum nitrate aqueous solution according to Comparative Example 3.

FIG. 8 shows a graph showing the infrared absorption signals of the adsorbed CO on Examples 1 and 2C, and Comparative Example 3 at 300° C.

FIG. 9 shows a graph showing the relationship between the vibration frequency of the adsorbed CO and temperature for Examples 1 and 2C, and Comparative Example 3.

FIG. 10 shows a graph showing the CO purification rate of Catalyst 1, Catalyst 2, and Comparative Catalyst 3 in a catalyst performance test using a test gas of CO=10000 ppm/O₂=5000 ppm.

FIG. 11 shows a graph showing the C₃H₆ purification rate of Catalyst 1, Catalyst 2, and Comparative Catalyst 3 in a catalyst performance test using a test gas of C₃H₆=200 ppm/O₂=5000 ppm.

FIG. 12 shows an electron micrograph of a hydrothermal redox aged substance originally having a platinum cluster of around 17 atoms on alumina according to Example 4.

FIG. 13 shows an electron micrograph of a hydrothermal redox aged substance originally having a platinum cluster of around 62 atoms (14 kDa) on alumina according to Example 5.

FIG. 14 shows an electron micrograph of a hydrothermal redox aged substance of platinum-supporting alumina originally synthesized by an impregnation method utilizing a platinum nitrate aqueous solution according to Comparative Example 6.

FIG. 15 shows a graph showing the CO purification rate of Catalyst 4, Catalyst 5, and Comparative Catalyst 6 in a catalyst performance test using a test gas of CO=10000 ppm/O₂=5000 ppm.

FIG. 16 shows a graph showing the C₃H₆ purification rate of Catalyst 4, Catalyst 5, and Comparative Catalyst 6 in a catalyst performance test using a test gas of C₃H₆=200 ppm/O₂=5000 ppm.

FIG. 17 shows a graph showing the relationship between the mean particle size measured by CO-pulse and hydrothermal ageing temperature for Examples 1 and 2C, and Comparative Example 3.

### DETAILED DESCRIPTION OF THE INVENTION

One aspect of the present invention is directed to a composition comprising platinum (Pt) nanoparticles and an inorganic oxide, wherein the Pt nanoparticles have no more than 100 Pt atoms, wherein the Pt nanoparticles have a mean particle size of 1 nm to 10 nm with a standard deviation (SD) no more than 1 nm.

The Pt nanoparticles can have no more than 100 Pt atoms (corresponding to mass number of no more than 24 kDa with organic protecting ligands), preferably, no more than 75 Pt atoms; more preferably, no more than 65 Pt atoms.

Alternatively, the Pt nanoparticles can have 2-100 Pt atoms, 30-100 Pt atoms, 40-80 Pt atoms, or 55-65 Pt atoms.

The Pt nanoparticles can have mass number of 8-20 kDa, 8-18 kDa, or 8-16 kDa with organic protecting ligands of phenyl ethanethiol, for example.

In some embodiments, the Pt nanoparticles can have a mean particle size of 1 nm to 10 nm with a SD no more than 0.8 nm, 0.6 nm, 0.5 nm, 0.4 nm, or 0.3 nm.

The Pt nanoparticles can have a mean particle size of 1 nm to 5 nm with a SD no more than 1.0 nm, 0.8 nm, 0.6 nm, 0.5 nm, 0.4 nm, or 0.3 nm. The Pt nanoparticles can have a mean particle size of 1 nm to 4 nm with a SD no more than 1.0 nm, 0.8 nm, 0.6 nm, 0.5 nm, 0.4 nm, or 0.3 nm. The Pt nanoparticles can have a mean particle size of 1 nm to 3 nm with a SD no more than 1.0 nm, 0.8 nm, 0.6 nm, 0.5 nm, 0.4 nm, or 0.3 nm. The Pt nanoparticles can have a mean particle size of 2 nm to 3 nm with a SD no more than 1.0 nm, 0.8 nm, 0.6 nm, 0.5 nm, 0.4 nm, or 0.3 nm.

To the inventors' surprise, they have found that the Pt nanoparticles of the present invention have shown improved thermostabilities and enhanced TOF after harsh hydrothermal ageing condition, when compared with the conventional Pt nanoparticles.

The Pt nanoparticles can have a mean particle size of no more than 15 nm after hydrothermal redox aging at 600° C. for 4 hours, wherein the mean particle size is measured by Transmission Electron Microscope (TEM). The Pt nanoparticles can have a mean particle size of no more than 13 nm after hydrothermal redox aging at 600° C. for 4 hours, wherein the mean particle size is measured by TEM. The Pt nanoparticles can have a mean particle size of no more than 10 nm after hydrothermal redox aging at 600° C. for 4 hours, wherein the mean particle size is measured by TEM. The Pt nanoparticles can have a mean particle size of no more than 20 nm after hydrothermal redox aging at 700° C. for 4 hours, wherein the mean particle size is measured by TEM. The Pt nanoparticles can have a mean particle size of no more than 18 nm after hydrothermal redox aging at 700° C. for 4 hours, wherein the mean particle size is measured by TEM. The Pt nanoparticles can have a mean particle size of no more than 16 nm after hydrothermal redox aging at 700° C. for 4 hours, wherein the mean particle size is measured by TEM.

The Pt nanoparticles can have a mean particle size of no more than 25 nm after hydrothermal redox aging at 800° C. for 4 hours, wherein the mean particle size is measured by TEM. The Pt nanoparticles can have a mean particle size of no more than 24 nm after hydrothermal redox aging at 800° C. for 4 hours, wherein the mean particle size is measured by TEM. The Pt nanoparticles can have a mean particle size of no more than 23 nm after hydrothermal redox aging at 800° C. for 4 hours, wherein the mean particle size is measured by TEM.

The Pt nanoparticles can have a mean particle size of no more than 50 nm after aging at 1000° C. for 4 hours, wherein the mean particle size is measured by TEM. The Pt nanoparticles can have a mean particle size of no more than 40 nm after aging at 1000° C. for 4 hours, wherein the mean particle size is measured by TEM. The Pt nanoparticles can have a mean particle size of no more than 30 nm after aging at 1000° C. for 4 hours, wherein the mean particle size is measured by TEM.

The Pt nanoparticles can have a mean particle size of no more than 30 nm after hydrothermal redox aging at 800° C. for 4 hours, wherein the mean particle size is measured by CO-pulse method. The Pt nanoparticles can have a mean particle size of no more than 25 nm after hydrothermal redox aging at 800° C. for 4 hours, wherein the mean particle size is measured by CO-pulse method.

The Pt nanoparticles can have a mean particle size of no more than 60 nm after hydrothermal redox aging at 900° C. for 4 hours, wherein the mean particle size is measured by CO-pulse method. The Pt nanoparticles can have a mean particle size of no more than 55 nm after hydrothermal redox aging at 900° C. for 4 hours, wherein the mean particle size is measured by CO-pulse method. The Pt nanoparticles can have a mean particle size of no more than 50 nm, 45 nm, or 40 nm after hydrothermal redox aging at 900° C. for 4 hours, wherein the mean particle size is measured by CO-pulse method.

The Pt nanoparticles can have a mean particle size of no more than 85 nm after aging at 1000° C. for 4 hours, wherein the mean particle size is measured by CO-pulse method. The Pt nanoparticles can have a mean particle size of no more than 80 nm after aging at 1000° C. for 4 hours, wherein the mean particle size is measured by CO-pulse method.

In some embodiments, the Pt nanoparticles are atomically resolved. The atomically resolved Pt nanoparticles can have 12 to 28 Pt atoms; in some embodiments, the atomically resolved Pt nanoparticles can have 14 to 20 Pt atoms; in further embodiments, the atomically resolved Pt nanoparticles can have 15-19 Pt atoms whose content can be more than 70% of total Pt nanoparticle cluster synthesized.

The composition can have the peak in the wavenumber spectrum of CO adsorbed on platinum of no more than 2080 cm⁻¹ at 200° C., measured by IR spectroscopy. The composition can have the peak in the wavenumber spectrum of CO adsorbed on platinum of no more than 2070 cm⁻¹ at 200° C., measured by IR spectroscopy.

The inorganic oxide can be selected from the group consisting of alumina, magnesia, silica, zirconia, lanthanum, cerium, neodymium, praseodymium, yttrium oxides, and mixed oxides or composite oxides thereof. Preferably, the inorganic oxide is alumina or a lanthana/alumina composite oxide. The Pt nanoparticles can be supported on the inorganic oxide.

### Definitions

The acronym “PGM” as used herein refers to “platinum group metal”. The term “platinum group metal” generally refers to a metal selected from the group consisting of Ru, Rh, Pd, Os, Ir and Pt, preferably a metal selected from the group consisting of Ru, Rh, Pd, Ir and Pt. In general, the term “PGM” preferably refers to a metal selected from the group consisting of Rh, Pt and Pd.

The term “atomically resolved” as used herein refers to “atomically precise synthesized” nanoparticle cluster materials with narrow distribution of +/−10 atoms, preferably +/−5 atoms, more preferably +/−2 atoms. The atomically resolved clusters can be obtained typically two processes. One is tuning the experimental conditions (e.g. solvent, organic ligands, temperature, pH . . . ) where the target cluster is chemically extremely stable compared to the other size of the clusters. Another process is size-selection of the target cluster typically using chromatography, electrophoresis, or mass spectrometry.

The “TEM” is a method for the particle size measurement as used herein. High angle annular dark filed scanning transmission electron microscopy images were recorded using a JEOL ARM200CFE fitted with an aberration corrector. The catalyst powders of Pt/Al₂O₃ were ground between two glass slides and dusted onto a holey carbon coated Cu TEM grid.

The “CO-pulse” is a method for the particle size measurement as used herein. CO-pulse adsorption experiments were performed at 50° C., followed by pre-adsorption of CO₂ to quench the CO uptake site by Al₂O₃ support, by using a metal dispersion analyzer (BEL-METAL, MicrotracBEL). The catalyst samples were pretreated by 10% O₂/He gas at 600° C. for 20 min and subsequent 3% H₂/He gas at 300° C. for 10 min, before the measurement.

The “mean particle size” estimated by TEM means the mean diameter of the particle with the assumption that a sphere shape of the Pt particles is supported on the oxide materials. The diameter (2R) can be calculated as follows;

2R=2\sqrt{A/π}

where A is the area of the particle measured by TEM.

The “mean particle size” estimated by CO-pulse means the mean diameter of the particle with the assumption that a sphere shape of the Pt particles is supported on the oxide materials. The mean particle size can be calculated with the data of Pt metal dispersion, which is representing the ratio of the surface atoms to total atoms, and volumetric mass density of the corresponding Pt bulk materials.

The “MALDI” is a method to ionize the synthesized nanoparticle cluster materials for mass spectrometry based on matrix-assisted laser desorption and ionization technique. MALDI mass spectra were collected by a spiral time-of-flight mass spectrometer (JEOL, JMSS3000) with a semiconductor laser. DCTB63 was used as the MALDI matrix. To minimize dissociation of the cluster caused by laser irradiation, we used a cluster-to-matrix ratio of 1:1000.

The “IR spectroscopy” is a method for the vibrational frequency measurement of CO adsorbed on Pt nanoparticle clusters as used herein. Diffuse Reflectance Infrared Fourier Transform Spectroscopy was carried out under a flow of 1% CO/He, using a FTIR spectrometer of FT/IR-6600 FV (JASCO) with MCT detector. The spectra were recorded with the sample at 100° C., 200° C., 300° C. and 400° C. The catalyst samples were pretreated by 10% O₂/He gas at 600° C. for 20 min and subsequent 3% H₂/He gas at 300° C. for 10 min, before the measurement.

The “hydrothermal ageing” is a method to reproduce the deterioration state of a catalyst used in actual applications. The samples were set in an electric furnace where mixture of steam and alternating reducing/oxidation gasses shown in Table 1 are introduced.

The term “loading” as used herein refers to a measurement in units of g/ft³ on a metal weight basis.

The term “washcoat” is well known in the art and refers to an adherent coating that is applied to a substrate usually during production of a catalyst.

The following examples merely illustrate the invention. Those skilled in the art will recognize many variations that are within the spirit of the invention and scope of the claims.

### EXAMPLES

Materials

All materials are commercially available and were obtained from known suppliers, unless noted otherwise.

### Example 1: Pt Cluster of Atomically Resolved 17 Atoms on Alumina

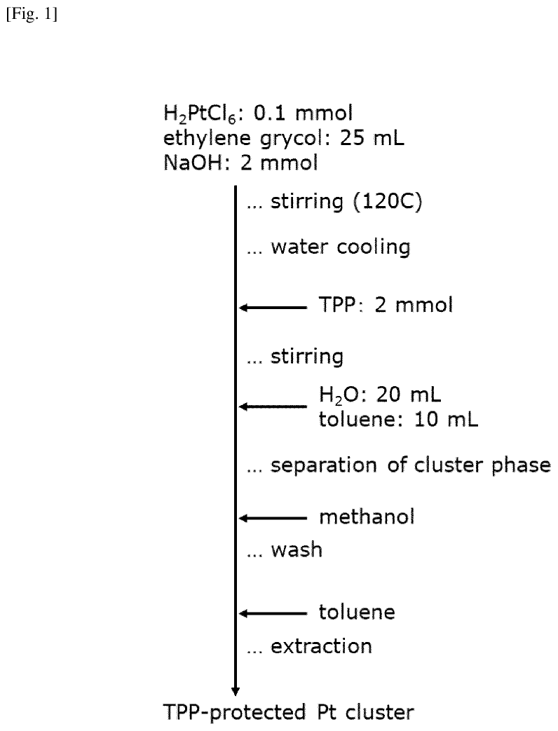

The Pt cluster protected by triphenylphosphine (TPP) was synthesized according to the flow shown in FIG. 1 and J. Phys. Chem. C 2017, 11002-11009.

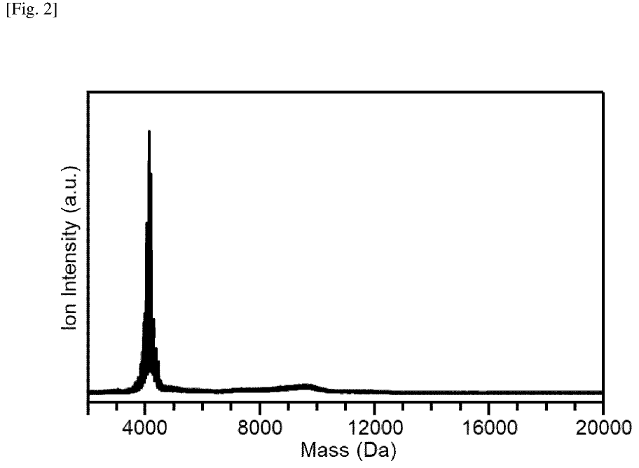

H₂PtCl₆.6H₂O (0.1 mmol) and NaOH (˜2 mmol) were dissolved in ethylene glycol (25 mL). NaOH was used to control the pH of the solution and thereby suppress the particle size obtained by the polyol reduction. The mixture was heated at 120° C. for 10 min to reduce Pt ions and produce CO catalyzed by Pt. After the solution cooled to room temperature (25° C.), acetone (10 mL) containing TPP (0.5245 g, 2 mmol) was added to this solution at once. After several minutes, toluene (˜20 mL) and water (˜20 mL) were added to the reaction solution. The Pt clusters were transferred into the organic phase. Then, the organic phase was separated from the water phase and dried with a rotary evaporator. The dried product was washed with water and then methanol to eliminate ethylene glycol and excess TPP. The mass number of the platinum cluster was confirmed by using matrix assisted laser desorption ionization (MALDI) mass spectrometry as shown in FIG. 2.

The dried product of Pt cluster of atomically resolved 17 atoms, whose content is more than 70% of total Pt nanoparticle cluster, was dissolved in toluene solution and then an alumina powder was mixed into the solution. The toluene solvent was then removed with a rotary evaporator. The dried Pt/alumina powder was heated to 500° C. under vacuum condition to remove TPP ligand and then calcined at 600° C. for 2 hours in static oven under atmosphere.

### Examples 2A to 2D: Pt Cluster of 35 to 71 Atoms on Alumina

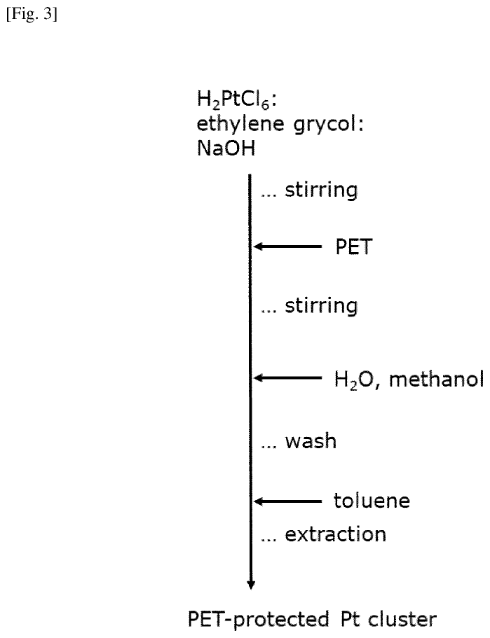

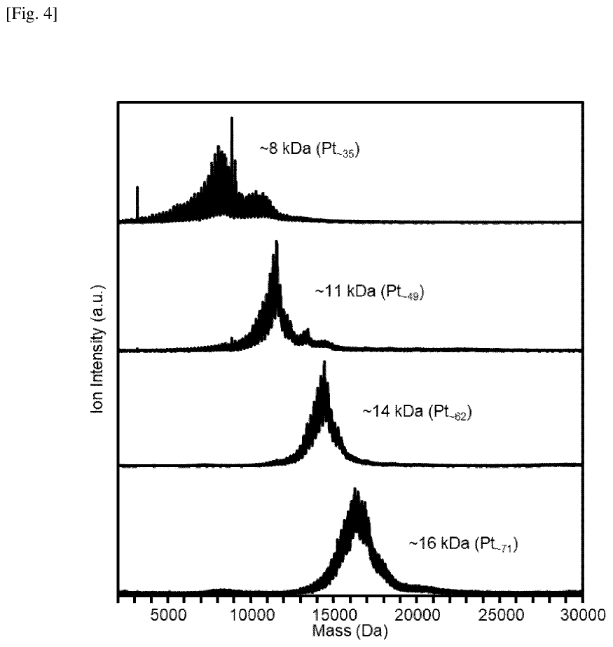

The platinum cluster was synthesized by using the polyol reduction method whose flow is shown in FIG. 3. First, by using an organic synthesizer, chloroplatinic acid and sodium hydroxide were dissolved in of ethylene glycol and adjusted to a predetermined pH. The mass number of the platinum cluster was varied by changing the pH, temperature and reaction time. After reaction, the protecting ligand of phenylethanethiol (PET) toluene solution was added and then the mixture was washed with water and methanol, and the synthesized platinum cluster was extracted into toluene to obtain a target platinum cluster. The mass number of the platinum cluster was confirmed by using MALDI mass spectrometry as shown in FIG. 4.

Example 2A is the product of Pt cluster of 35 atoms with the distribution of +/−5 atoms at full-width half-maximum, dissolved in toluene solution was mixed with an alumina powder. The toluene solvent was then removed with a rotary evaporator. The dried Pt/alumina powder was heated to 500° C. under vacuum condition to remove PET ligand and then calcined at 600° C. for 2 hours in static oven under atmosphere. Example 2B is the product of Pt cluster of 49 atoms with the distribution of +/−5 atoms at full-width half-maximum, dissolved in toluene solution was mixed with an alumina powder. The toluene solvent was then removed with a rotary evaporator. The dried Pt/alumina powder was heated to 500° C. under vacuum condition to remove PET ligand and then calcined at 600° C. for 2 hours in static oven under atmosphere. Example 2C is the product of Pt cluster of 62 atoms with the distribution of +/−5 atoms at full-width half-maximum, dissolved in toluene solution was mixed with an alumina powder. The toluene solvent was then removed with a rotary evaporator. The dried Pt/alumina powder was heated to 500° C. under vacuum condition to remove PET ligand and then calcined at 600° C. for 2 hours in static oven under atmosphere. Example 2D is the product of Pt cluster of 71 atoms with the distribution of +/−5 atoms at full-width half-maximum, dissolved in toluene solution was mixed with an alumina powder. The toluene solvent was then removed with a rotary evaporator. The dried Pt/alumina powder was heated to 500° C. under vacuum condition to remove PET ligand and then calcined at 600° C. for 2 hours in static oven under atmosphere.

### Comparative Example 3: Pt-Supporting Alumina Synthesized by an Impregnation Method

A platinum aqueous solution was impregnated into the alumina powder, and then dried in air at 150° C. for 2 hours. The dried powder was calcined at 600° C. for 2 hours.

### Example 4: A Hydrothermal Aged Substance Originally Having a Platinum Cluster of Atomically Resolved 17 Atoms on Alumina

The Pt cluster supported alumina in Example 1 was aged under hydrothermal redox condition shown in Table 1. The ageing temperature was 1000° C. and the duration was 4 hours.

TABLE 1

| | CO | H₂ | O₂ | H₂O | | |
|---|---|---|---|---|---|---|
| Condition | (%) | (%) | (%) | (%) | N₂ | Duration |
| Reducing | 3 | 3 | 0 | 10 | balance | 3 min |
| Oxidizing | 0 | 0 | 3 | 10 | balance | 3 min |

### Example 5: A Hydrothermal Aged Substance Originally Having a Platinum Cluster of Around 62 Atoms on Alumina

The Pt cluster supported alumina in Example 2 was aged under hydrothermal redox condition shown in Table 1. The ageing temperature was 1000° C. and the duration was 4 hours.

### Comparative Example 6: A Hydrothermal Aged Pt-Supporting Alumina Originally Synthesized by an Impregnation Method

The Pt cluster supported alumina of Comparative Example 3 was aged under hydrothermal redox condition shown in Table 1. The ageing temperature was 1000° C. and the duration was 4 hours.

Catalyst 1: A Honeycomb Catalyst Containing Example 1

Catalyst 1 is a honeycomb structured catalyst with coated washcoat containing alumina supporting Pt cluster of around 17 atoms (Example 1). The Pt cluster (0.15% of Pt by weight) supported alumina powder was mixed with a binder and water to form a slurry and coated on a honeycomb carrier. The coated honeycomb was calcined in air at 600° C. for 2 hours. For the honeycomb carrier, a cordierite carrier having a cell wall thickness of 4.0 mil with 400 cells per square inch was used. The amount of Pt/alumina washcoat was 60 g per 1 L of the carrier.

Catalyst 2: A Honeycomb Catalyst Containing Example 2C

Catalyst 2 is a honeycomb structured catalyst with coated washcoat containing alumina supporting Pt cluster of around 62 atoms (Example 2C). The Pt cluster (0.15% of Pt by weight) supported alumina powder was mixed with a binder and water to form a slurry and coated on a honeycomb carrier. The coated honeycomb was calcined in air at 600° C. for 2 hours. For the honeycomb carrier, a cordierite carrier having a cell wall thickness of 4.0 mil with 400 cells per square inch was used. The amount of Pt/alumina washcoat was 60 g per 1 L of the carrier.

Comparative Catalyst 3: A Honeycomb Catalyst Containing Comparative Example 1

Comparative Catalyst 3 is a honeycomb structured catalyst with coated washcoat containing Pt-supporting alumina synthesized by an impregnation method (Comparative Example 3). The Pt (0.15% of Pt by weight) supported alumina powder was mixed with a binder and water to form a slurry and coated on a honeycomb carrier. The coated honeycomb was calcined in air at 600° C. for 2 hours. For the honeycomb carrier, a cordierite carrier having a cell wall thickness of 4.0 mil with 400 cells per square inch was used. The amount of Pt/alumina washcoat was 60 g per 1 L of the carrier.

Catalyst 4: A Hydrothermal Aged Catalyst Originally Containing Example 1

The honeycomb structured catalyst in Catalyst 1 was aged under hydrothermal redox condition shown in Table 1. The ageing temperature was 1000° C. and the duration was 4 hours.

Catalyst 5: A Hydrothermal Aged Catalyst Originally Containing Example 2C

The honeycomb structured catalyst in Catalyst 2 was aged under hydrothermal redox condition shown in Table 1. The ageing temperature was 1000° C. and the duration was 4 hours.

Comparative Catalyst 6: A Hydrothermal Aged Catalyst Originally Containing Comparative Example 3

The honeycomb structured catalyst in Comparative Catalyst 3 was aged under hydrothermal redox condition shown in Table 1. The ageing temperature was 1000° C. and the duration was 4 hours.

### Experimental Results

Geometric Structure of Pt Nanoparticle Clusters by TEM

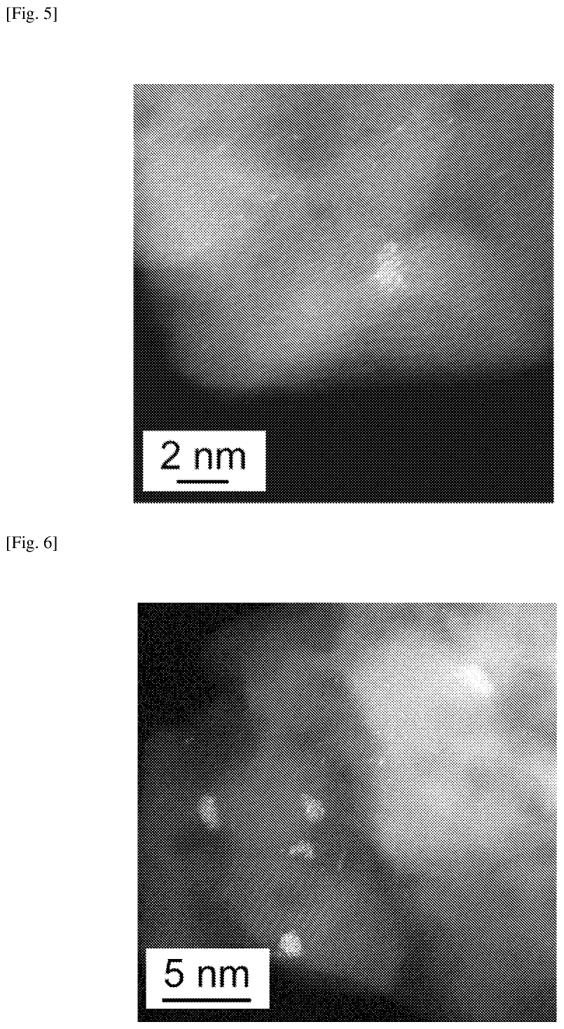

The examples and the comparative examples were observed by using a scanning transmission electron microscope (ARM 200 CFE: manufactured by JEOL Ltd). As shown in FIGS. 5 and 6, platinum clusters with non-fcc-type geometric structure was observed on alumina in Examples 1 and 2C. The mean particle size and the standard deviation (SD) were listed in Table 2. The mean particle size was very small, which is below 1.5 nm and very narrow size distribution was observed, within 0.5 nm at SD.

TABLE 2

| | Mean Particle | Standard |
|---|---|---|
| Sample | Size (nm) | Deviation (nm) |
| Example 1 (Pt₁₇ cluster) | 1.07 | +/−0.24 |
| Example 2C (Pt₆₂ cluster) | 1.28 | +/−0.43 |
| Comparative Example 3 | 3.10 | +/−3.14 |
| (Pt—N impreg.) | | |

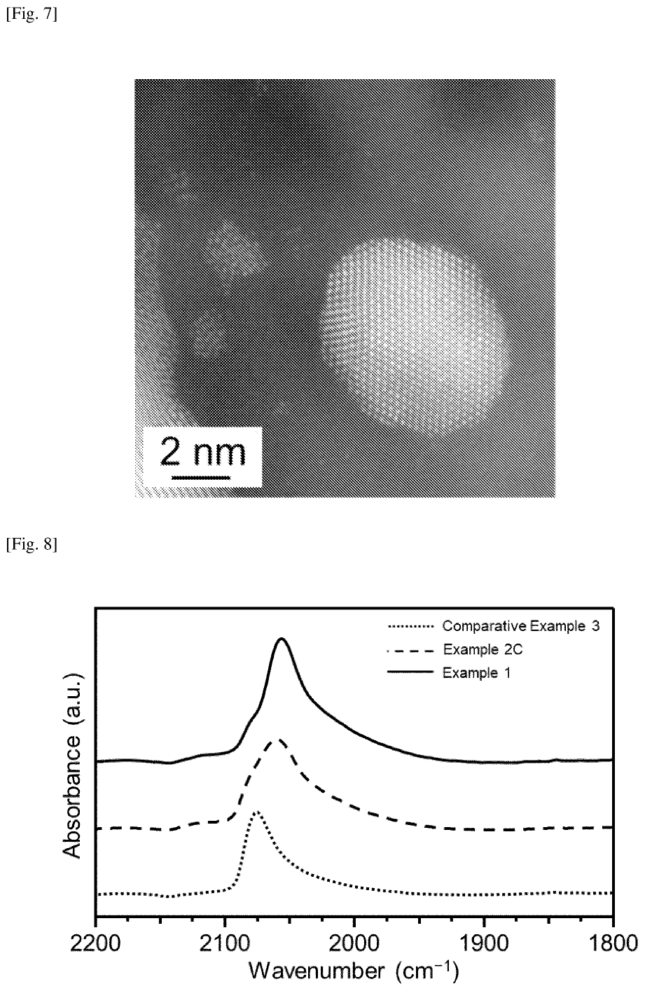

On the other hand, as shown in FIG. 7, in Comparative Example 3, platinum particles in a fcc-based crystalline form of about 5 nm to 10 nm were observed on alumina. It is considered that this platinum particle in a crystalline form is composed of 1000 to 10000 platinum atoms. As is clear from comparison between FIGS. 3 and 4, the atomic arrangement of Pt nanoparticles supported on the alumina is quite different between the substance according to the examples and the substance according to the comparative example.

IR Spectroscopic Measurement of Adsorbed CO on Pt Nanoparticle Clusters

IR spectroscopic measurement of adsorbed CO was performed by using an infrared spectrometer (FT/IR-6600 FV: manufactured by JASCO Corporation). In the adsorbed CO-FTIR measurement, the substances according to the examples and the comparative example were placed in the reaction cell of the infrared spectrometer, and the IR spectrum of CO adsorbed by platinum was measured while introducing CO gas into the reaction cell.

FIG. 8 shows IR absorption spectra for Examples 1 and 2C, and Comparative Example 3 at the temperature of 300° C. The strong IR absorption signals assignable to a-top CO state were observed for examples and comparative example while the peak position for the examples was lower wavenumber (vibration frequency), a finding which is indicting that adsorbed CO is more activated through string chemical interaction with Pt of the examples as respect to that of the comparative example.

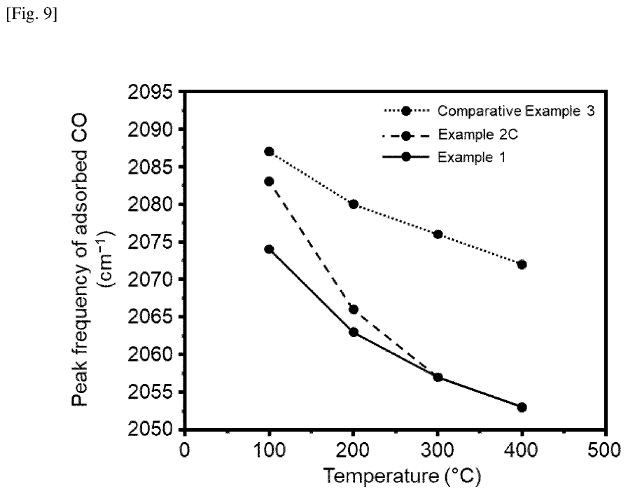

FIG. 9 shows the relationship between the vibration frequency of the adsorbed CO on Pt nanoparticles of Examples 1 and 2C, and Comparative Example 3 and the temperature obtained by the IR measurement. Here, the vibration frequency of the adsorbed CO refers to the wavenumber of CO at which the strongest peak is observed in the IR spectra obtained at each temperature, and in FIG. 9, the lower vibration frequency of the adsorbed CO means more activation of the adsorbed CO on the Pt nanoparticles. As shown in FIG. 9, in the material according to the examples, the adsorbed CO was activated more at a lower temperature. Also, surprisingly, the vibration frequencies of the adsorbed CO at 200° C. of the substance according to Examples 1 and 2C are smaller than that of the adsorbed CO at 400° C. of the substance according to Comparative Example 3.

Catalytic Oxidation Performance Test

Testing Conditions

Catalyst performance tests were carried out on two types of test gases having compositions of CO=10000 ppm/O₂=5000 ppm and C₃H₆=200 ppm/O₂=5000 ppm for the catalysts according to the example and the comparative example.

In the catalyst performance test, the gas flow rate was set to 60000 hr as a space velocity, the temperature was increased from 100° C. to 400° C. at a rate of 20° C./min, the gas composition after passage through the catalyst was measured by AO-2020 (manufactured by ABB), so as to measure the purification rates of CO and C₃H₆.

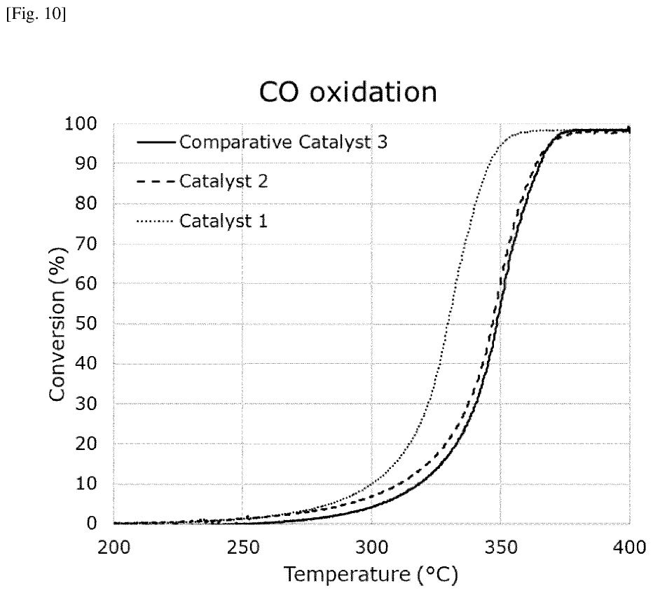

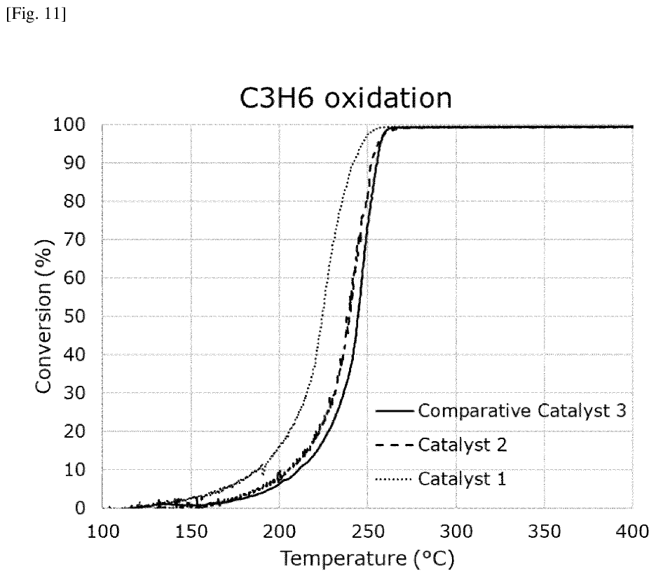

As shown in FIGS. 10 and 11, Catalysts 1 and 2 activated the reaction of CO and C₃H₆ at a lower temperature and showed a higher purification rate of CO and C₃H₆ than Comparative Catalyst 3. Catalysts 1 and 2 therefore have higher catalytic activity for oxidation of CO and C₃H₆ than Comparative Catalyst 3. The results evidently indicate that Catalysts 1 and 2 have a superior property as an oxidation catalyst for CO and hydrocarbon and the like.

The turnover frequencies (TOF) of the catalysts in a test using a test gas having a composition of CO=10000 ppm/O₂=5000 ppm and C₃H₆=200 ppm/O₂=5000 ppm were calculated and compared for Catalysts 1 and 2, and Comparative Catalyst 3. The TOF of the catalysts refers to the maximum frequency (s⁻¹) that a reactant molecule can convert into a product molecule per active site of Pt catalyst and the larger TOF of the catalysts means higher catalytic performance with the higher reaction rate.

As shown in Tables 3 and 4, the TOF of C₃H₆ oxidation is higher for Catalyst 1 than Comparative Catalyst 3. For Catalyst 1, the improved C₃H₆ oxidation performance was originating from both TOF and higher dispersion (i.e. smaller particle size).

TABLE 3

| | TOF (s⁻¹) at 300° C. |
|---|---|
| Sample | for CO oxidation |
| Catalyst 1 (Pt₁₇ cluster) | 3.09 |
| Catalyst 2 (Pt₆₂ cluster) | 2.94 |
| Comparative Catalyst 3 | 3.50 |
| (Pt—N impreg.) | |

TABLE 4

| | TOF (s⁻¹) at 170° C. |
|---|---|
| Sample | for C₃H₆ oxidation |
| Catalyst 1 (Pt₁₇ cluster) | 0.034 |
| Catalyst 2 (Pt₆₂ cluster) | 0.018 |
| Comparative Catalyst 3 | 0.027 |
| (Pt—N impreg.) | |

Toughness Toward Harsh Hydrothermal Ageing Treatment

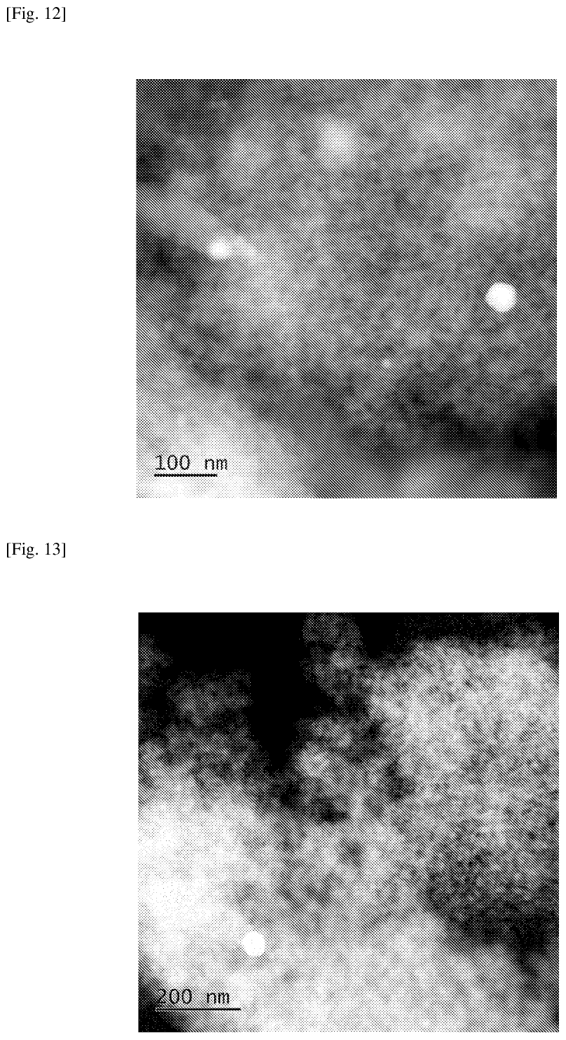

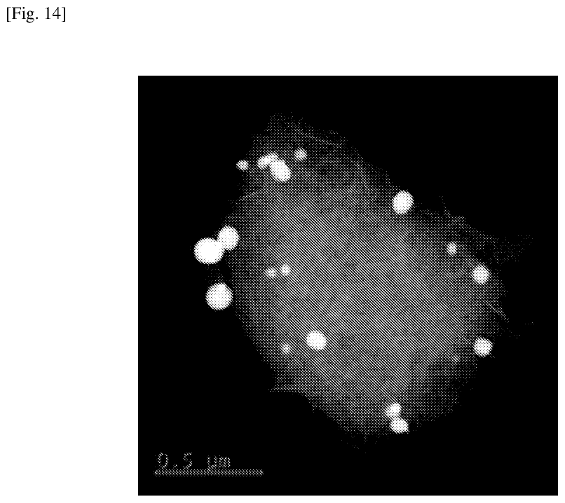

Examples 4 and 5, and Comparative Example 6 were observed by TEM and the results are shown in FIGS. 12-14. The Pt nanoparticles were aggregated and sintered after the ageing treatment to be larger particle size. The mean particle size and the SD were listed in Table 5. The mean particle size was smallest for Example 4 with 25.3 nm diameter while the mean particle size for Example 5 and Comparative Example 6 were about three times larger than that of Example 4. The results evidently indicate that the Pt catalyst with the non-fcc type cluster of around 17 atoms of Pt has a superior property of thermostability during harsh ageing likely due to unexpected strong interaction with alumina carrier surface.

TABLE 5

| | Mean | Standard |
|---|---|---|
| | Particle | Deviation |
| Sample | Size (nm) | (nm) |
| Example 4 | 25.3 | +/−19.4 |
| Example 5 | 71 | +/−30.2 |
| Comparative | 77.5 | +/−29.9 |
| Example 6 | | |

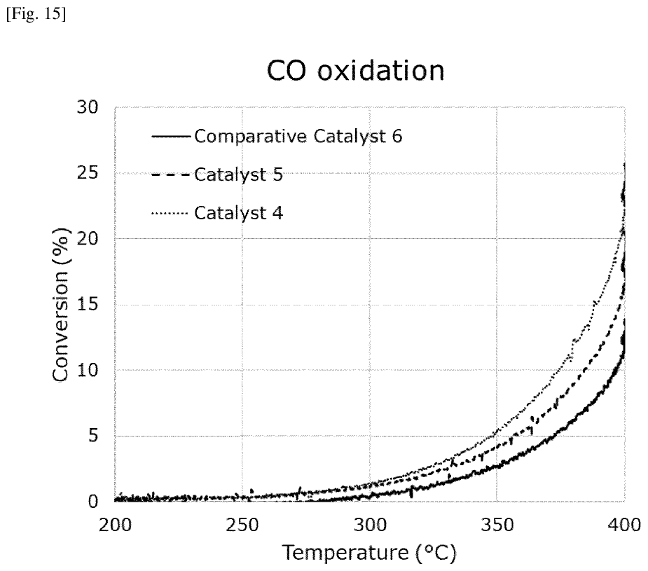

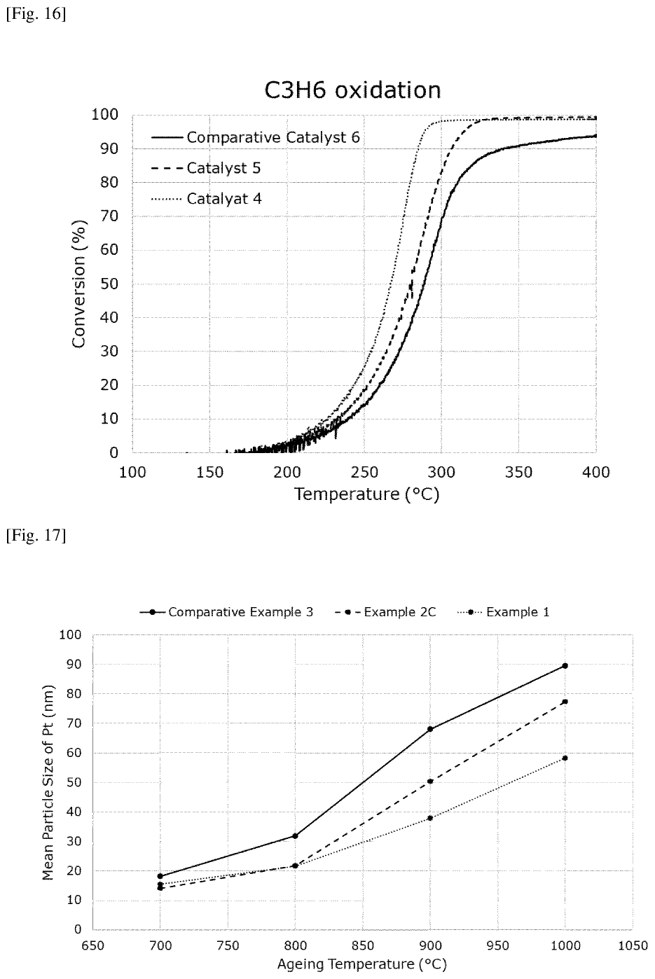

As shown in FIGS. 15 and 16, Catalysts 4 and 5 activated the reaction of CO and C₃H₆ at a lower temperature and showed a higher purification rate of CO and C₃H₆ than Comparative Catalyst 6. Catalysts 4 and 5 therefore have higher catalytic activity for oxidation of CO and C₃H₆ than Comparative Catalyst 6. The results evidently indicate that Catalysts 4 and 5 have a superior property as an oxidation catalyst for CO and hydrocarbon and the like.

As shown in Tables 6 and 7, the TOF of CO and C₃H₆ oxidation are higher for Catalyst 4 than Comparative Catalyst 6. For Catalyst 4, the improved catalytic oxidation performance was originating from both TOF and higher dispersion (i.e. smaller particle size). The use of Pt cluster material around 17 atoms for the oxidation catalyst is potentially reduce the usage amount of platinum effectively, in other words, it is possible to reduce the usage amount of rare and precious platinum resources as well as to reduce the environmental burden like CO and hydrocarbon emissions.

TABLE 6

| | TOF (s⁻¹) at 380° C. |
|---|---|
| Sample | for CO oxidation |
| Catalyst 4 | 99.8 |
| Catalyst 5 | 57.3 |
| Comparative | 60.5 |
| Catalyst 6 | |

TABLE 7

| | TOF (s⁻¹) at 240° C. |
|---|---|
| Sample | for C₃H₆ oxidation |
| Catalyst 4 | 2.87 |
| Catalyst 5 | 1.69 |
| Comparative | 2.01 |
| Catalyst 6 | |

As shown in FIG. 17, the mean particle sizes after the hydrothermal redox ageing at 700° C., 800° C., 900° C., and 1000° C., estimated by CO-pulse were smaller for Examples 1 and 2C than Comparative Example 3. Especially, the size of Example 1 is smallest after ageing of 900° C. and 1000° C. The Pt cluster of around 17 atoms is therefore more thermostable compared to the larger Pt cluster of around 62 atoms.

1. A composition comprising platinum (Pt) nanoparticles and an inorganic oxide, wherein the Pt nanoparticles have no more than 100 Pt atoms, wherein the Pt nanoparticles have a mean particle size of 1 nm to 10 nm with a standard deviation (SD) no more than 1 nm.

2. The composition of claim 1, wherein the Pt nanoparticles have a mean particle size of 1 nm to 5 nm.

3. The composition of claim 1, wherein the Pt nanoparticles have a mean particle size of no more than 15 nm after hydrothermal redox aging at 600° C. for 4 hours, wherein the mean particle size is measured by TEM.

4. The composition of claim 1, wherein the Pt nanoparticles have a mean particle size of no more than 20 nm after hydrothermal redox aging at 700° C. for 4 hours, wherein the mean particle size is measured by TEM.

5. The composition of claim 1, wherein the Pt nanoparticles have a mean particle size of no more than 25 nm after hydrothermal redox aging at 800° C. for 4 hours, wherein the mean particle size is measured by TEM.

6. The composition of claim 1, wherein the Pt nanoparticles have 2 to 100 Pt atoms.

7. The composition of claim 6, wherein the Pt nanoparticles have 30 to 100 Pt atoms.

8. The composition of claim 1, wherein the Pt nanoparticles have a mean particle size of no more than 50 nm after aging at 1000° C. for 4 hours, wherein the mean particle size is measured by TEM.

9. The composition of claim 1, wherein the Pt nanoparticles have a mean particle size of no more than 30 nm after hydrothermal redox aging at 800° C. for 4 hours, wherein the mean particle size is measured by CO-pulse method.

10. The composition of claim 1, wherein the Pt nanoparticles have a mean particle size of no more than 60 nm after hydrothermal redox aging at 900° C. for 4 hours, wherein the mean particle size is measured by CO-pulse method.

11. The composition of claim 1, wherein the Pt nanoparticles have a mean particle size of no more than 80 nm after aging at 1000° C. for 4 hours, wherein the mean particle size is measured by CO-pulse method.

12. The composition of claim 1, wherein the Pt nanoparticles are atomically resolved.

13. The composition of claim 12, wherein the Pt nanoparticles have 12 to 28 Pt atoms.

14. The composition of claim 1, wherein frequency of adsorbed CO molecule is lower than 2080 cm⁻¹ at 200° C. by IR spectroscopy.

15. The composition of claim 1, wherein frequency of adsorbed CO molecule is lower than 2070 cm⁻¹ at 200° C. by IR spectroscopy.

16. The composition of claim 1, wherein the inorganic oxide is selected from the group consisting of alumina, magnesia, silica, zirconia, lanthanum, cerium, neodymium, praseodymium, yttrium oxides, and mixed oxides or composite oxides thereof.

17. The composition of claim 16, wherein the inorganic oxide is alumina or a lanthana/alumina composite oxide.

18. The composition of claim 1, wherein the Pt nanoparticles are supported on the inorganic oxide.
